(19) United States
(12) Patent Application Publication
(10) Pub. No.: US 2005/0065229 A1
(43) Pub. Date: Mar. 24, 2005

(54) Process for oxidizing a fluoropolymer and multilayer structures comprising this oxidized fluoropolymer

(76) Inventors: Anthony Bonnet, Beaumont Le Roger (FR); Barbara Ramfel, Longpont Sur Orge (FR); Pascal Sebire, Sant-Aubin Le Vertueux (FR); Michael Werth, Bernay (FR); Thierry Pascal, Charly (FR)

Correspondence Address: Thomas F. Roland, Esq.;Atofina Chemicals, Inc., 26th Floor, 2000 Market St., Philadelphia, PA, 19103, US

(21) Appl. No.: 10/900,940

(22) Filed: Jul. 28, 2004

Related U.S. Application Data
(60) Provisional application No. 60/509,619, filed on Oct. 8, 2003.

(30) Foreign Application Priority Data
Jul. 28, 2003 (FR) 03.09223

(51) Int. Cl. C08J 3/28

(52) U.S. Cl. 522/150

(57) ABSTRACT

The present invention relates to a process for oxidizing a fluoropolymer, comprising the steps of: a) forming a fluoropolymer is into a film, a sheet, granules or powder; b) exposing the products from step a), in the presence of oxygen, to photon (γ) or electron (β) irradiation with a dose of between 1 and 15 Mrad; and c) optionally treating the product obtained in b) in order to remove all or some of the by-product impurities. The oxidized fluoropolymer thus obtained may be used as such or in a blend with at least one polymer. Structures comprising at least one layer of this oxidized fluoropolymer and at least one layer of another material may be formed into bottles, tanks, containers, pipes, hoses and vessels of all sorts. They may also be converted into films with which packaging is made. The invention also relates to the oxidized fluoropolymer.

This application claims benefit, under U.S.C. § 119(a) of French National Applications Number 03.09223, filed Jul. 28, 2003; and also claims benefit, under U.S.C. § 119(e) of U.S. provisional application 60/509,619, filed Oct. 8, 2003.

### FIELD OF THE INVENTION

Fluoropolymers, for example those based on vinylidene fluoride CF2=CH2 (VDF) such as PVDF (polyvinylidene fluoride), are known to offer excellent mechanical stability properties, very great chemical inertness and good ageing resistance. These qualities are exploited for various fields of application. For example, mention may be made of the manufacture of extruded or injection-moulded parts for the chemical engineering industry or for microelectronics, the use in the form of impermeable ducts for transporting gases or hydrocarbons, the production of films or coatings for protection in the architectural field, and the production of protective elements for electrical engineering uses.

However, this chemical inertness of fluoropolymers means that it is difficult to bond them or combine them with other materials. The present invention discloses a process in which a fluoropolymer is oxidized. This fluoropolymer thus modified may be easily bonded to or combined with other materials. The process of the invention consists in irradiating the fluoropolymer in the presence of oxygen.

### BACKGROUND OF THE INVENTION

Patent EP 214880 discloses a process for manufacturing polyvinylidene fluoride copolymers by grafting a monomer onto the polyvinylidene fluoride by means of ionizing radiation, which process comprises the following steps:
a)—immersing a polyvinylidene fluoride powder or film in a solution of a monomer chosen from the group comprising acrylamide, styrene, methylstyrene, allyl glycidyl ether, 2-vinylpyridine, 4-vinylpyridine, 2-methyl-5-vinylpyridine, dimethylaminoethyl acrylate, dimethylaminoethyl methacrylate, dimethylaminopropyl acrylate, dimethylaminopropyl methacrylate, diethylaminoethyl acrylate, diethylaminoethyl methacrylate, diethylaminopropyl acrylate, diethylaminopropyl methacrylate, dimethylaminopropyl methacrylamide, N-vinylpyrrolidone, N-vinylcaprolactam, acyloxy styrenes and hydroxystyrenes, vinyl sulphonic acid and its derivatives, acrylic acid and methacrylic acid, in order to impregnate the polyvinylidene fluoride powder or film with the said monomer;
b)—irradiating the impregnated powder or film by means of ionizing radiation in the absence of oxygen; and
c)—then subjecting the grafted copolymer obtained to a chemical reaction in order to confer an ionic character on it when the grafted monomer does not have an ionic character.

Patent Application WO 00/17889 discloses power cable jackets comprising, in succession, a layer formed from an ethylene/alkyl acrylate/maleic anhydride terpolymer and a layer of a VDF/HFP fluorocopolymer. To improve the adhesion of these layers, the assembly is subjected to ionizing radiation.

U.S. Pat. No. 5,576,106 discloses a process for grafting an unsaturated functional monomer onto the surface of a powdered fluoropolymer. Powdered maleic anhydride is blended with the fluoropolymer and then they are put in a polyethylene bag and, after the air contained in the bag has been expelled, the bag containing the powder blend is subjected to irradiation of between 3 and 6 Mrad. According to a variant, the maleic anhydride is dissolved in acetone, the solution is mixed with the powdered fluoropolymer and then the acetone is evaporated. The material is then irradiated as above. The grafted fluoropolymer is then used in multilayer structures. In all the examples, only fluoroelastomers are used.

Patent Application JP 56-139517 A published on 31 Oct. 1981 discloses the grafting of maleic anhydride onto polypropylene or high-density polyethylene pre-irradiated in the presence of oxygen. The polyethylene powder is irradiated in the presence of oxygen, which thus creates peroxide functional groups, and is then blended with maleic anhydride in an extruder.

Patent Application EP 1054023 discloses a process for modifying a fluoropolymer in the form of a latex, in which the polymer undergoes partial dehydrofluorination using a base and is then oxidized by hydrogen peroxide. This modified fluoropolymer is useful as an adhesion tie between a fluoropolymer and a metal or another polymer incompatible with the fluoropolymer.

A much simpler process has now been found for modifying a fluoropolymer and for obtaining an oxidized fluoropolymer. All that is required is to irradiate it in the presence of oxygen.

### SUMMARY OF THE INVENTION

The present invention relates to a process for oxidizing a fluoropolymer, in which:
a) the fluoropolymer is made in the form of films, sheets, granules or powder;
b) the products from step a) are exposed, in the presence of oxygen, to photon (γ) or electron (β) irradiation with a dose of between 1 and 15 Mrad; and
c) the product obtained at b) is optionally treated in order to remove all or some of the by-product impurities.

The oxidized fluoropolymer thus obtained may be used as such or in a blend with at least one polymer chosen from the same, but unoxidized, fluoropolymer, another fluoropolymer and another, non-fluorinated polymer such as, for example, an acrylic polymer. As examples acrylic polymers, mention may be made of PMMA and impact modifiers of the core/shell type.

The invention also relates to structures comprising at least one layer of this oxidized fluoropolymer and at least one layer of another material.

The invention also relates to the use of these structures to obtain a barrier effect.

These structures are barriers to many fluids and in particular to petrol and to air-conditioning fluids.

These structures may be formed into bottles, tanks, containers, pipes, hoses and vessels of all sorts. They may also be converted into films with which packaging is made.

The combined use of a fluoropolymer impermeable to a polar fluids and of a polyolefin impermeable to polar fluids is particularly beneficial as it allows a barrier to be obtained that is very effective against petrols containing liquids such as M15 (42.5% isooctane, 42.5% toluene and 15% methanol by volume) or TF1 (45% toluene, 45% isooctane and 10% ethanol).

The invention also relates to structures in which the fluoropolymer is used to protect substrates.

In the above structures, the oxidized fluoropolymer may be used by itself or in a blend as mentioned above.

The invention also relates to the oxidized fluoropolymer. It relates to the oxidized fluoropolymer in a blend with at least one polymer chosen from the same, but unoxidized, fluoropolymer, another fluoropolymer and another, non-fluorinated polymer such as, for example, an acrylic polymer. As examples of acrylic polymers, mention may be made of PMMA and impact modifiers of the core/shell type.

### DETAILED DESCRIPTION OF THE INVENTION

The term fluoropolymer thus denotes any polymer that has in its chain at least one monomer chosen from compounds that contain a vinyl group capable of opening in order to be polymerized and that contain, directly attached to this vinyl group, at least one fluorine atom, at least one fluoroalkyl group or at least one fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also contain non-fluorinated monomers such as ethylene.

For example, the fluoropolymer is chosen from:
homopolymers and copolymers of vinylidene fluoride (VDF) preferably containing at least 50% by weight of VDF, the comonomer being chosen from chlorotrifluoroethylene (CTFE), hexafluoropropylene (HFP), trifluoroethylene (VF3) and tetrafluoroethylene (TFE);
homopolymers and copolymers of trifluoroethylene (VF3); and
copolymers, and especially terpolymers, that combine the residues of the chlorotrifluoroethylene (CTFE), tetrafluoroethylene (TFE), hexafluoropropylene (HFP) and/or ethylene units and optionally VDF and/or VF3 units.

Advantageously, the fluoropolymer is polyvinylidene fluoride (PVDF) homopolymer or copolymer. Preferably, the PVDF contains at least 50%, more preferably at least 75% and even better at least 85% VDF by weight. The comonomer is advantageously HFP.

Advantageously, the PVDF has a viscosity ranging from 100 Pa.s to 2000 Pa.s, the viscosity being measured at 230° C. with a shear rate of 100 s⁻¹ using a capillary rheometer. These PVDFs are in fact well suited to extrusion and injection moulding. Preferably, the PVDF has a viscosity ranging from 300 Pa.s to 1200 Pa.s, the viscosity being measured at 230° C. with a shear rate of 100 s⁻¹ using a capillary rheometer.

With regard to the irradiation, and firstly to step a), the products are advantageously packaged in polyethylene bags, and the bags are not inerted. Advantageously, the fluoropolymer is in powder form. The bags may also include an aluminium layer in addition to the polyethylene layer. It is unnecessary to irradiate in the presence of pure oxygen, all that is required is that oxygen be present. It is possible to irradiate in the presence of an inert gas containing oxygen. The “inert gas” denotes a gas that is not involved in the irradiation reaction or in the modification of the fluoropolymer by oxygen. Advantageously, the proportion of oxygen is between 1 and 20 vol % per 99 to 80 vol % of inert gas, respectively. Advantageously, irradiation is carried out in the presence of air. As regards the method of irradiation in step b), it is equally possible to use electron irradiation, more commonly known as beta irradiation, and photon irradiation, more commonly known as gamma irradiation. Advantageously, the dose is between 2 and 12 Mrad and preferably between 2 and 8 Mrad.

With regard to step c), the impurities may be removed by any means. A washing operation may be carried out with solvents that are inert vis-a-vis the oxidized fluoropolymer. It is also possible, more simply, to vacuum degas the product recovered in step b).

With regard to the blending, the oxidized fluoropolymer thus obtained may be used as it is or in a blend with at least one polymer chosen from the same, but unoxidized, fluoropolymer, another fluoropolymer and another, non-fluorinated, polymer such as, for example, an acrylic polymer. As examples of acrylic polymers, mention may be made of PMMA and impact modifiers of the core/shell type. The proportion of oxidized fluoropolymer may be between 1 and 99% by weight of the blend. Advantageously, the proportion of oxidized fluoropolymer is between 2 and 30% by weight of the blend. Preferably, the proportion of oxidized fluoropolymer is between 2 and 15% by weight of the blend.

The invention also relates to structures. As examples of structures according to the invention, mention may be made of that comprising, in succession:
an inner layer in contact with the fluid to be transported stored, consisting of the oxidized fluoropolymer according to the invention and, directly attached to the latter, an outer polyolefin layer. The polyolefin of the outer layer may be functionalized. This structure is useful for motor-vehicle petrol tanks. According to a variant, this structure includes a layer of fluoropolymer, preferably PVDF, placed beside the oxidized fluoropolymer. That is to say the structure comprises, in succession, a layer of fluoropolymer, preferably PVDF, a layer consisting of the fluoropolymer oxidized according to the invention and, directly attached to the latter, an outer polyolefin layer. The layer of oxidized fluoropolymer is a tie layer between the PVDF layer and the polyolefin layer.

In the above structures, it is possible to place, between the oxidized fluoropolymer layer and the polyolefin layer, a layer of functionalized polyolefin having functional groups capable of reacting with the oxidized fluoropolymer. For example, the functionalized polyolefin layer consists of a copolymer of ethylene, glycidyl methacrylate and optionally an alkyl acrylate, optionally in a blend with polytheylene. As another example, the functionalized polyolefin layer consists of a copolymer of ethylene, maleic anhydride and optionally an alkyl acrylate, the copolymer being optionally in a blend with polyethylene.

In the above structures, the inner layer in contact with the fluid to be transported or stored may contain carbon black, carbon nanotubes or any other additive capable of making it conductive in order to prevent static electricity from building up.

As an example of structures according to the invention, mention may be made of that comprising, in succession:
a layer consisting of the fluoropolymer oxidized according to the invention, placed between two polyolefin layers. This structure is useful for motor-vehicle petrol tanks.

In the above structures, it is possible to place, between the oxidized fluoropolymer layer and one or both polyolefin layers, a layer of functionalized polyolefin having functional groups capable of reacting with the oxidized fluoropolymer. For example, the layer of functionalized polyolefin consists of a copolymer of ethylene, glycidyl methacrylate and optionally an alkyl acrylate, optionally in a blend with polyethylene. As another example, the functionalized polyolefin layer consists of a copolymer of ethylene, maleic anhydride and optionally an alkyl acrylate, the copolymer being optionally in a blend with polyethylene.

As another example of structures according to the invention, mention may be made of that comprising, in succession:
an inner layer in contact with the fluid to be transported or stored, consisting of the fluoropolymer oxidized according to the invention and, directly attached to the latter, an outer polyamide layer. This structure is useful for motor-vehicle fuel pipes or hoses. According to a variant, this structure includes a layer of fluoropolymer, preferably PVDF, placed beside the oxidized fluoropolymer. That is to say the structure comprises, in succession, a layer of fluoropolymer, preferably PVDF, a layer consisting of the fluoropolymer oxidized according to the invention and, directly attached to the latter, an outer polyamide layer. The layer of oxidized fluoropolymer is a tie layer between the PVDF layer and the polyamide layer.

In the above structures, it is possible to place, between the oxidized fluoropolymer layer and the polyamide layer, a layer of functionalized polymer having functional groups capable of reacting with the fluoropolymer, this functionalized polymer being compatible with the polyamide.

In the above structures, the inner layer in contact with the fluid to be transported or stored may contain carbon black, carbon nanotubes or any other additive capable of making it conductive in order to prevent static electricity from building up.

As another example of structures according to the invention, mention may be made of that comprising, in succession:
an outer layer of oxidized fluoropolymer of the invention and, directly attached to the latter, a layer of a substrate. The oxidized fluoropolymer layer is used as a layer for protecting the substrate. The substrate may be a component of the body of a motor vehicle or an architectural component. According to a variant, this structure includes a layer of fluoropolymer, preferably PVDF, placed beside the oxidized fluoropolymer. That is to say the structure comprises, in succession, a layer of fluoropolymer, preferably PVDF, a layer consisting of the fluoropolymer oxidized according to the invention and, directly attached to the latter, a layer of a substrate. The layer of oxidized fluoropolymer is a tie layer between the PVDF layer and the substrate layer.

In the above structures, it is possible to place, between the oxidized fluoropolymer layer and the substrate layer, a layer of functionalized polymer having functional groups capable of reacting with the oxidized fluoropolymer, this polymer being compatible with the substrate.

The oxidized fluoropolymer or PVDF used as layer for protecting a substrate may contain the usual UV stabilizers and/or radiation-absorbent fillers.

These structures may be manufactured by standard techniques, such as extrusion, coextrusion, coextrusion blow moulding, coating, extrusion coating.

The invention also relates to the oxidized fluoropolymer. It relates to the oxidized fluoropolymer in a blend with at least one polymer chosen from the same, but unoxidized, fluoropolymer, another fluoropolymer and another, non-fluorinated, polymer such, for example, an acrylic polymer. As examples of acrylic polymers, mention may be made of PMMA and impact modifiers of the core/shell type. The proportion of oxidized fluoropolymer may be between 1 and 99% by weight of the blend. Advantageously, the proportion of oxidized fluoropolymer is between 2 and 30% by weight of the blend. Preferably, the proportion of oxidized fluoropolymer is between 2 and 15% by weight of the blend.

### EXAMPLES

The following polymers were used:
KYNAR 710: PVDF homopolymer from Atofina, having an MVI (Melt Volume Index) of 20 cm³/10 min (230° C./5 kg);
KYNAR 711: the same as above but in powder form; and
LOTADER 8840: an ethylene/glycidyl methacrylate copolymer having an MFI of 5 g/10 min at 190° C./2.16 kg (92% ethylene and 8% glycidyl methacrylate by weight). MFI denotes the melt flow index.

### Example 1

### According to the Invention

A KYNAR 711 powder was placed in a sealed bag comprising a layer of paper, a layer of aluminium and a layer of polyethylene. This bag was itself placed in an identical bag, both bags being hermetically sealed by heat sealing. This KYNAR powder was irradiated to 10 Mrad. After the bags were opened under a hood and after devolatilization for at least two hours, in order to remove all the volatiles produced during the irradiation step, the oxidized fluoropolymer was bonded to the LOTADER 8840 from Atofina in a symmetrical oxidized PVDF (500 μm)/LOTADER 8840 (200 μm)/oxidized PVDF (500 μm) structure. A peel test was carried out on this structure and a peel force of 35 N/cm was measured.

### Example 2

### Comparative Example

A KYNAR 711 powder was bonded to LOTADER 8840 from Atofina in a symmetrical PVDF (500 μm)/LOTADER 8840 (200 μm)/PVDF (500 μm) structure. A peel test was carried out on this structure and a peel force of 0.5 N/cm was measured.

### Example 3

### According to the Invention

KYNAR 710 granules were placed in a sealed bag comprising a layer of paper, a layer of aluminium and a layer of polyethylene. This bag was itself placed in an identical bag, both bags being hermetically sealed by heat sealing. The KYNAR was irradiated to 5 Mrad. After the bags were opened under a hood and after devolatilization for at least two hours, in order to remove all the volatiles produced during the irradiation step, the oxidized fluoropolymer was bonded to the LOTADER 8840 from Atofina in a symmetrical oxidized PVDF (500 μm)/LOTADER 8840 (200 μm)/oxidized PVDF (500 μm) structure. A peel test was carried out on this structure and a peel force of 30 N/cm was measured.

### Example 4

### According to the Invention

A KYNAR® 711 powder was placed in a sealed bag comprising a layer of paper, a layer of aluminium and a layer of polyethylene. This bag was itself placed in an identical bag, both bags being hermetically sealed by heat sealing. This KYNAR powder was irradiated to 10 Mrad. After the bags were opened under a hood and after devolatilization for at least two hours, in order to remove all the volatiles produced during the irradiation step, the oxidized fluoropolymer was bonded to an aluminium foil at 250° C. The structure obtained could not be peeled apart.

### Example 5

### According to the Invention

A KYNAR 711 powder was placed in a sealed bag comprising a layer of paper, a layer of aluminium and a layer of polyethylene. This bag was itself placed in an identical bag, both bags being hermetically sealed by heat sealing. This KYNAR powder was irradiated to 10 Mrad. After the bags were opened under a hood and after devolatilization for at least two hours, in order to remove all the volatiles produced during the irradiation step, the oxidized fluoropolymer was blended with an unmodified fluoropolymer in proportions of 50/50 by weight. This blend was bonded to the LOTADER 8840 from Atofina in a symmetrical oxidized PVDF (500 μm)/LOTADER 8840 (200 μm)/oxidized PVDF (500 μm) structure. A peel test was carried out on this structure and a peel force of 35 N/cm was measured.

1. Process for oxidizing a fluoropolymer, comprising the steps of:
a) forming a fluoropolymer is into a film, a sheet, granules or powder;
b) exposing the products from step a), in the presence of oxygen, to photon (γ) or electron (β) irradiation with a dose of between 1 and 15 Mrad; and
c) optionally treating the product obtained in b) in order to remove all or some of the by-product impurities.

2. Process according to claim 1, in which the fluoropolymer is PVDF.

3. Process according claim 2, in which the PVDF contains at least 85% VDF by weight.

4. Process according to claim 1, in which the irradiation dose is between 2 and 8 Mrad.

5. Structure comprising at least one layer of the oxidized fluoropolymer prepared according to the process of claim 1 and at least one layer of another material.

6. Structure according to claim 5, in which the oxidized fluoropolymer is in a blend with at least one polymer selected from the group consisting of the same, but unoxidized, fluoropolymer; another fluoropolymer; and another, non-fluorinated polymer.

7. Structure according to claim 6, in which the other, non-fluorinated polymer is chosen from PMMA and impact modifiers of the core/shell type.

8. Structure according to claim 5 comprising bottles, tanks, containers, pipes, hoses, vessels, films and packaging.

9. Structure according to claim 5, comprising an inner layer in contact with a fluid to be transported or stored, consisting of the oxidized fluoropolymer and, directly attached to the latter, an outer polyolefin layer.

10. Structure according to claim 9, in which a PVDF layer is placed beside the oxidized fluoropolymer layer.

11. Structure according to claim 9, in which a layer of functionalized polyolefin having functional groups capable of reacting with the oxidized fluoropolymer is placed between the oxidized fluoropolymer layer and the polyolefin layer.

12. Structure according to claim 5, consisting of the oxidized fluoropolymer placed between two polyolefin layers.

13. Structure according to claim 12, in which a layer of functionalized polyolefin having functional groups capable of reacting with the oxidized fluoropolymer is placed between the oxidized fluoropolymer layer and one of the two polyolefin layers.

14. Structure according to claim 5, comprising an inner layer in contact with a fluid to be transported or stored, consisting of the oxidized fluoropolymer and, directly attached to the latter, an outer polyamide layer.

15. Structure according to claim 14, in which a PVDF layer is placed beside the oxidized fluoropolymer layer.

16. Structure according to claim 14, in which a layer of functionalized polymer having functional groups capable of reacting with the oxidized fluoropolymer is placed between the oxidized fluoropolymer layer and the polyamide layer, this functionalized polymer being compatible with the polyamide.

17. Structure according to claim 14, in which the inner layer in contact with the fluid to be transported or stored may contain carbon black, carbon nanotubes or any other additive capable of making it conductive in order to prevent static electricity from building up.

18. Structure according to claim 5, comprising an outer layer of fluoropolymer and, directly attached to the latter, a layer of a substrate.

19. Structure according to claim 18, in which a PVDF layer is placed beside the oxidized fluoropolymer layer.

20. Structure according to claim 18, in which a layer of functionalized polymer having functional groups capable of reacting with the oxidized fluoropolymer is placed between the oxidized fluoropolymer layer and the substrate layer, this functionalized polymer being compatible with the substrate.

21. An oxidized fluoropolymer.

22. Polymer according to claim 21, in which the fluoropolymer is PVDF.

23. Polymer according to claim 22, in which the PVDF contains at least 85% VDF by weight.

24. Polymer according to claim 21 wherein the oxidized fluoropolymer is in a blend with at least one polymer chosen from the same, but unoxidized, fluoropolymer, another fluoropolymer and another, non-fluorinated polymer.

25. Polymer according to claim 24, in which the other, non-fluorinated polymer is chosen from PMMA and impact modifiers of the core/shell type.
